(19) United States
(12) Patent Application Publication
(10) Pub. No.: US 2021/0227106 A1
(43) Pub. Date: Jul. 22, 2021

(54) PORTABLE IMAGE PICKUP APPARATUS

(71) Applicant: CANON KABUSHIKI KAISHA, Tokyo (JP)

(72) Inventors: Shinga Nakashima, Kanagawa (JP); Ryoji Okuno, Kanagawa (JP)

(21) Appl. No.: 17/148,771

(22) Filed: Jan. 14, 2021

(30) Foreign Application Priority Data
Jan. 21, 2020 (JP) 2020-007681

(51) Int. Cl. H04N 5/225

(52) U.S. Cl. CPC H04N 5/2253; H04N 5/2254

(57) ABSTRACT

An image pickup apparatus that does not disturb a photographing operation, has high portability, and facilitates attachment and detachment. The image pickup apparatus includes a body part and a frame part. The body part has an image pickup lens. The frame part has an opening. The frame part is provided with a notch section that is formed by cutting out a part of the frame part in a direction different from a natural falling direction of the image pickup apparatus.

### BACKGROUND OF THE INVENTION

### Field of the Invention

The present invention relates to an image pickup apparatus like a digital camera, and in particular relates to an image pickup apparatus having improved portability.

### Description of the Related Art

There is a known digital camera of which a camera body is provided with a carabiner part so as to improve portability by increasing wearability (see Japanese Laid-Open Patent Publication (Kokai) No. 2009-147443 (JP 2009-147443A)).

However, in the technique described in the above-mentioned publication, the carabiner part is formed as a member separate from a housing of the digital camera and is connected to a code that has flexibility so that the code can be rolled round in a cord reel. Accordingly, when a user holds the digital camera in a state where the code is not pulling out from the cord reel, the holding of the camera is difficult because the user covers the carabiner part with a hand, which may disturb a photographing operation.

### SUMMARY OF THE INVENTION

The present invention provides an image pickup apparatus that does not disturb a photographing operation, has high portability, and facilitates attachment and detachment.

Accordingly, a first aspect of the present invention provides an image pickup apparatus including a body part configured to have an image pickup lens, and a frame part configured to have an opening. The frame part is provided with a notch section that is formed by cutting out a part of the frame part in a direction different from a natural falling direction of the image pickup apparatus.

Accordingly, a second aspect of the present invention provides an image pickup apparatus including a body part configured to have an image pickup lens, and a frame part configured to form an opening together with the body part. At least a part of the frame part is slidable between a first position in which the opening closes and a second position in which a gap that communicates with the opening is generated.

According to the present invention, an image pickup apparatus that does not disturb a photographing operation, has high portability, and facilitates attachment and detachment can be provided.

Further features of the present invention will become apparent from the following description of exemplary embodiments with reference to the attached drawings.

### BRIEF DESCRIPTION OF THE DRAWINGS

FIG. 1A and FIG. 1B are external perspective views showing a digital camera concerning a first embodiment.

FIG. 2 is a front view showing the digital camera of FIG. 1A.

FIG. 3A and FIG. 3B are views respectively showing a photographing form and holding state of the digital camera of FIG. IA.

FIG. 4A and FIG. 4B are views describing a dress-up panel of the digital camera of FIG. 1A.

FIG. 5A and FIG. 5B are front views showing digital cameras of first and second examples concerning a second embodiment.

FIG. 6 is a perspective view schematically showing a configuration of a digital camera of a third example concerning the second embodiment.

FIG. 7A is an external perspective view showing the digital camera of a first example concerning a third embodiment. FIG. 7B is a perspective view showing main components relevant to an operation of an attachment part.

FIG. 8A through FIG. 8D are views describing first and second positions of an attachment part of the digital camera of FIG. 7A.

FIG. 9A through FIG. 9D are views describing first and second positions of an attachment part of a digital camera of a second example concerning the third embodiment.

FIG. 10A and FIG. 10B are external perspective views respectively showing the digital camera of FIG. 9A and a digital camera of a modified example thereof.

FIG. 11A, FIG. 11B, and FIG. 11C are external perspective views showing a digital camera concerning a fourth embodiment in various positions of an attachment part.

FIG. 12A through FIG. 12D are views describing main components relevant to an operation of the attachment part of the digital camera of FIG. 11A.

FIG. 13A through FIG. 13D are views describing an operation of the attachment part of the digital camera of FIG. 11A.

FIG. 14A and FIG. 14B are external perspective views showing a digital camera concerning a fifth embodiment.

### DESCRIPTION OF THE EMBODIMENTS

Hereafter, embodiments according to the present invention will be described in detail by referring to the drawings.

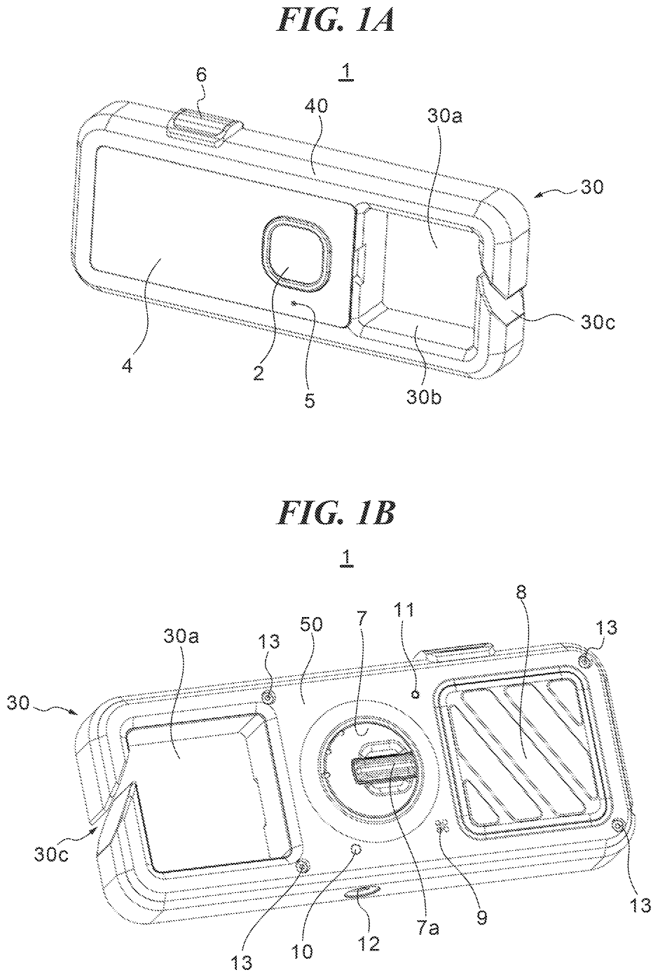

FIG. 1A is an external perspective view showing a digital camera 1 as an example of an image pickup apparatus concerning a first embodiment viewed from a front side (an object side). FIG. 1B is an external perspective view showing the digital camera 1 viewed from an opposite side (a rear side) of an object.

The digital camera 1 has a front cover 40, a rear cover 50, and an image pickup lens 2. The front cover 40 and rear cover 50 are tightened and fixed with screws 13, and the front cover 40 and the rear cover 50 that are tightened constitute an exterior of the digital camera 1. A tripod hole 12 is formed in a bottom surface of the exterior of the digital camera 1.

A rectangular frame part is formed in one end of the digital camera I in a longitudinal direction. This frame part is used to attach the digital camera 1 to mounted members (not shown), such as clothing like a belt loop of trousers of a user, a belt of a rucksack, and a stop ring attached at a predetermined position. Accordingly, the frame part provided in the end of the digital camera 1 in the longitudinal direction is referred to as an “attachment part” in the following description.

The attachment part 30 is constituted by arranging a frame member 30b having an opening 30a in an inner circumferential surface of a rectangular frame part provided in the front cover 40 and the rear cover 50. However, the configuration of the attachment part 30 is not limited to such a configuration. The attachment part 30 may consist of the front cover 40 and rear cover 50 only. Alternatively, the attachment part may be formed with a rectangular frame member only by combining the frame member to the front cover 40 and rear cover 50. The configuration of the attachment part 30 will be mentioned later.

It should be noted that a part except the attachment part of the digital camera 1 and digital cameras concerning the following embodiments is referred to as a “camera body” in the following description. That is, the camera body is the part in which an image pickup lens 2, a mode switching dial 7, a rear grip part 8, etc. are provided.

The image pickup lens 2 is arranged in a surface of the front cover 40 that is parallel to an opening plane of the opening 30a. A dress-up panel 4 can be detachably attached to the front cover 40. Details of the dress-up panel 4 are mentioned later. A microphone hole 5, which is mainly used to take sound from outside when capturing a movie, is formed on the front cover 40. The microphone hole 5 is formed so as to penetrate the dress-up panel 4 so that the dress-up panel 4 may not close the microphone hole 5. A pressing type release button 6 is provided in the upper part of the front cover 40. When a user presses the release button 6, a photographing instruction is input to a control circuit (not shown) provided inside a housing of the digital camera 1.

In the rear cover 50, the mode switching dial 7, the rear grip part 8, a loudspeaker hole 9, an LED window 10, and a reset button 11 are provided on a surface that is parallel to the opening plane of the opening 30a. The mode switching dial 7 is an operating member used to switch a photographing mode and to turn off a power source of the digital camera 1. The rear grip part 8 is formed as an uneven surface to be used as a finger placing part that improves grip performance (holdability) by placing right hand fingers at the time of photographing. The LED window 10 is provided to notify a user of a charge state, a connectable state with an external device, etc. by combinations of luminescent colors and luminescent states of an LED (not shown). An operation sound etc. are emitted from the loudspeaker hole 9. The reset button 11 is an operating member used to return various settings of the digital camera 1 to settings at the time of factory shipments.

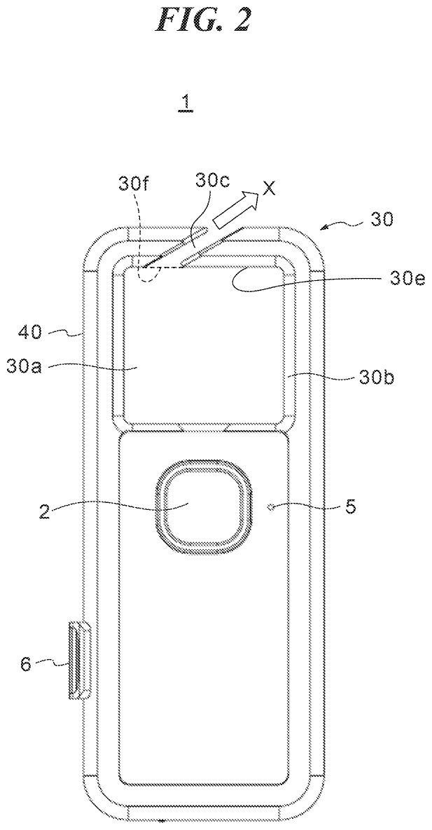

Next, the configuration of the attachment part 30 constituted so as to bring the digital camera 1 by attaching to clothing and to keep by hanging will be described. FIG. 2 is a front view (viewed from the side of the image pickup lens 2) of the digital camera 1. The attachment part 30 is constituted by forming rectangular frame parts in the front cover 40 and rear cover 50 so as to surround the frame member 30b having the opening 30a. A notch section 30c that cuts out the frame member 30b, front cover 40, and rear cover 50 is formed in the attachment part 30. The digital camera 1 can be detachably attached to a mounted member (not shown) using the notch section 30c.

When the digital camera 1 is hung to the mounted member using the opening 30a, the digital camera 1 usually becomes attitude where the release button 6 is positioned lower than the image pickup lens 2 (a ground side (not shown)) because the part in which the image pickup lens 2, the mode switching dial 7, etc. are provided is heavy. At this time, the notch section 30c comes to the position that is opposite to the image pickup lens 2 in the attachment part 30 located in the upper position as shown in FIG. 2.

In a state where the mounted member is inserted into the opening 30a of the attachment part 30, a mounted-member contact surface 30e of the frame member 30b becomes a contact surface against the mounted member due to self-weight of the digital camera 1. Then, the notch section 30c is provided in a part of the mounted-member contact surface 30e in the digital camera 1. That is, the mounted member hooks and holds the digital camera 1 by the mounted-member contact surface 30e.

The notch section 30c is formed so as to cut out a part of the mounted-member contact surface 30e and is formed by cutting in a direction different from a direction that intersects perpendicularly with the mounted-member contact surface 30e. As shown in FIG. 2, the notch section 30c is formed so as to have inclination X of a predetermined angle to the mounted-member contact surface 30e.

Accordingly, when the mounted member is attached to the opening 30a, the mounted member passes through the notch section 30c. In the meantime, since the notch section 30c is formed so as to have the inclination X to the mounted-member contact surface 30e, a gateway 30f of the notch section 30c contacts the mounted member. Accordingly, even if force that removes the digital camera 1 in a dropping direction (downward in FIG. 2) is applied by self-weight, the digital camera 1 does not fall.

In other words, since the digital camera 1 has a shape of a rectangular parallelepiped plate (rectangular shape) as a whole and the attachment part 30 is provided in one end in the longitudinal direction, the side of the attachment part 30 is lighter in the longitudinal direction of the digital camera 1. When the digital camera 1 falls naturally, it takes a posture in which the longitudinal direction becomes approximately parallel to a gravity direction and the side of the attachment part 30 becomes upper. Since the notch section 30c is formed in the attachment part 30 in the direction different from (being not parallel to) the falling direction (gravity direction) of the digital camera 1, the digital camera 1 does not fall easily, even if the mounted member contacts the gateway 30f.

When removing the digital camera 1 from the mounted member, a user locates the mounted member at the gateway 30f of the notch section 30c and moves the digital camera 1 in the inclination direction of the notch section 30c. A size of the opening 30a is preferably determined so as to be attachable to the mounted member. A width of the notch section 30c is preferably determined so that the mounted member will pass with no difficulty and the mounted member will not exit easily. Although the angle of the inclination X of the notch section 30c (the angle made with the mounted-member contact surface 30e) depends on a shape (a cylindrical shape or a thin strip shape, for example) and a thickness of the mounted member, the angle preferably falls within a range of 20 degrees through 60 degrees in order to keep flexibility, for example.

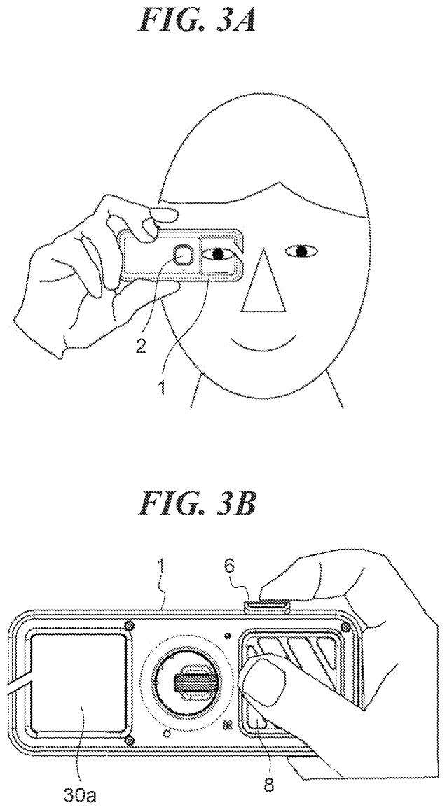

In the meantime, in the digital camera 1, the opening 30a of the attachment part 30 that has a frame shape functions also as a transparent finder that is penetrated in a photographing direction. FIG. 3A is a view showing an example of a photographing form using the digital camera 1. FIG. 3B is a view showing a state where a user is holding the digital camera 1 in the photographing form of FIG. 3A.

When photographing with the digital camera 1, the user is able to check a photographing area by holding the digital camera 1 toward an object and by visually recognizing (looking at) the object through the opening 30a that functions as the finder frame. The opening 30a has a rectangular shape (including a rectangle of which corners are rounded) in order to check verticality and horizontality of composition easily when a user checks an object through the opening 30a as a finder frame. The image pickup lens 2 is preferably arranged as close as possible to the opening 30a. This reduces a deviation between a field that a user sights and an actual image pickup area.

It should be noted that the shape of the opening 30a approximates a picked-up image. An aspect ratio of the opening 30a becomes a field angle at the time of image pick-up. For example, the aspect ratio becomes 1:1, 4:3, 3:4, or the like. Accordingly, it is not preferable to change the shape or to increase the size of the attachment part 30 by giving priority to the attachment function.

The relation between the attachment part 30 and the other members influences greatly the operability at the time of image pickup. Accordingly, next, the relation between the attachment part 30 and the other members will be described. The image pickup lens 2 is preferably arranged as close as possible to the opening 30a that functions as a finder frame. Thereby, the parallax between the image pickup lens 2 and the finder frame (opening 30a) in short-distance photographing can be reduced.

In the meantime, the image pickup lens 2 is preferably arranged as far as possible from the release button 6. This can effectively prevent a finger from blocking the image pickup lens 2 when a user holds the digital camera 1. Moreover, the attachment part 30 and the release button 6 are arranged at the positions that do not overlap mutually in an operation direction (press direction) of the release button 6. This is because the digital camera 1 is assumed that a user photographs with using a right hand only as shown in FIG. 3B. That is, if the notch section 30c of the attachment part 30 and the release button 6 are arranged at the positions that overlap in the operation direction of the release button 6, the finger of the right hand that holds the digital camera 1 will touch the notch section 30c at a time of an operation of the release button 6. Then, when the user holds the digital camera 1 with the fingers of the right hand, it becomes difficult to fix the digital camera 1 and the operability at the time of image pick-up will be lowered. Against this, since the notch section 30c is arranged so as not to overlap the release button 6 in the operation direction of the release button 6 in the digital camera 1 of the embodiment, occurrence of a failed image including image blur or inclined composition can be reduced.

The digital camera 1 is designed assuming that frequency of use in the photographing form of FIG. 3A is high. Accordingly, the attachment part 30, image pickup lens 2, and rear grip part 8 are arranged from the left side viewed from the user and the release button 6 is arranged above the rear grip part 8 in the digital camera 1 in order to further improve the operability at the time of image pick-up as shown in FIG. 1A and FIG. 1B. In this way, since a predetermined distance is secured between the attachment part 30 and the release button 6, the fingers of the right hand of the user do not contact the notch section 30c when an image pickup operation is performed while holding the digital camera 1 with the right hand as shown in FIG. 3B.

Moreover, the rear grip part 8 and the release button 6 are arranged closely. Thereby, since the user is able to grip the digital camera 1 so as to cover the rear grip part 8 by a palm when operating the release button 6, the user is able to operate (push) the release button 6 by stabilizing the posture of the digital camera 1. Furthermore, since the attachment part 30 is arranged so as to locate at the left side of the user when the user holds the rear grip part 8 with the right hand, even if the user holds the digital camera 1 by the right palm, the function as the finder of the attachment part 30 is not spoiled. The attachment part 30 is preferably arranged so as to fall within the left half of the digital camera 1 in a state where the user holds the digital camera 1 by the right palm from a view point of the operability. Moreover, the rear grip part 8 is preferably arranged so as to fall within the right half of the back face of the digital camera 1 in the same state.

As shown in FIG. 1B, the mode switching dial 7 is arranged between the attachment part 30 and the rear grip part 8 in the digital camera 1. The mode switching dial 7 is a rotary dial. A user is able to switch a photographing mode between movie capturing and still-image capturing and to turn off the power of the digital camera by rotating the mode switching dial 7 by hanging a finger on a finger hook 7a. The finger hook 7a is provided in the position near the rear grip part 8 rather than the attachment part 30, and it is easy to hang a finger on the finger hook 7a in the state where a user held the digital camera 1 with a right hand. Moreover, when a user performs an image pickup operation by holding the digital camera 1 with a right hand, a thumb can be hung on the finger hook 7a even in a state where an index finger is hung on the release button 6 because the release button 6 is arranged near the rear grip part 8. Thereby, the user is able to perform the image pickup operation and mode switching operation quickly by one hand operation.

Although the configuration assuming that a user holds the digital camera 1 with a right hand only and picks up an image has been described, a configuration assuming that a user holds the digital camera 1 with a left hand only and picks up an image may be employed. In such a case, a digital camera will be configured by mirror-inverting the configuration shown in FIG. 2 upside down.

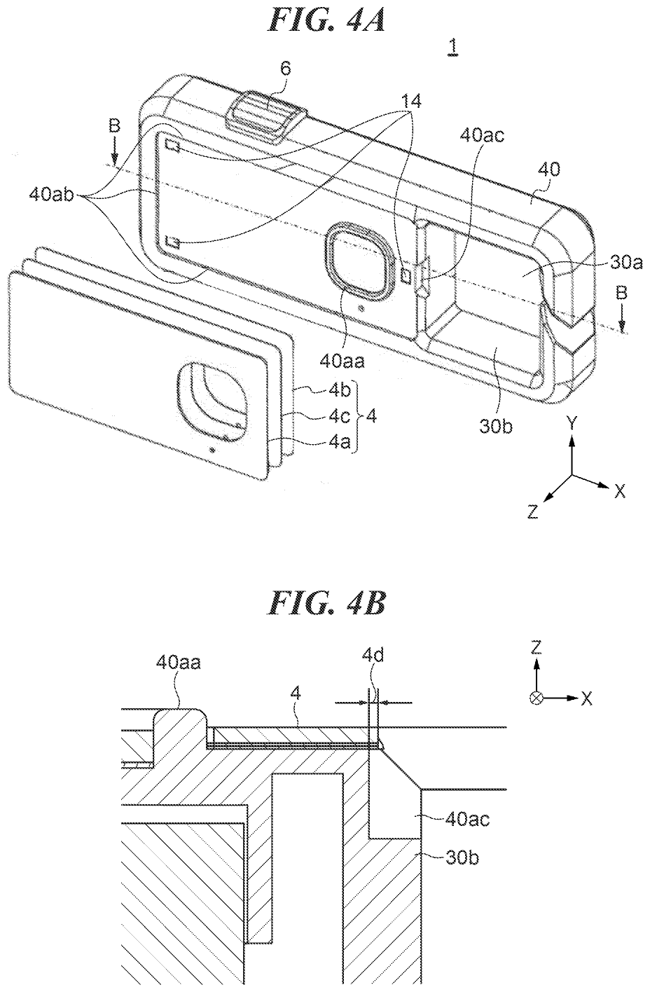

Next, the dress-up panel 4 will be described by referring to FIG. 4A and FIG. 4B. FIG. 4A is a perspective view showing a state of the digital camera 1 where the dress-up panel 4 is detached from the front cover 40. FIG. 4B is a partial sectional view showing the digital camera 1 taken along the line B-B in FIG. 4A. It should be noted that coordinate axes are shown in FIG. 4A and FIG. 4B to show mutual correspondence therebetween.

The dress-up panel 4 has a laminated configuration that is formed by adhering an appearance member 4a and a steel plate 4b by a sandwiched double-stick tape 4c. The appearance member 4a is a sheet member made from resin like polycarbonate to which printing or surface treatment is applied. The steel plate 4b is absorbed by magnets 14 provided in the front cover 40. There is a demand to change the appearance of the digital camera 1 depending on a scene or a situation in which the digital camera 1 is used. Accordingly, the dress-up panel 4 is preferably designed so that a user can easily replace it on the assumption that two or more sorts of dress-up panels 4 that have various appearance members 4a will be provided.

The dress-up panel 4 is positioned by a convex part 40aa that constitutes the outer circumference of the image pickup lens 2 and a standing wall 40ab formed in the front cover 40 so that a contour part of the dress-up panel 4 can be fitted. And the dress-up panel 4 is held with the three magnets 14 fixed to the front cover 40. It should be noted that the fixing mechanism is not limited to the configuration that can fix the dress-up panel 4 using the magnets 14. For example, when photographing at underwater or a waterside is not taken into consideration, a configuration that does not use the magnet 14 and steel plate 4b may be employed. In that case, the dress-up panel 4 is configured by using the double-stick tape 4c of which the side of the appearance member 4a has high adhesiveness and the side of the front cover 40 has low adhesiveness. In this case, the back face of the dress-up panel 4 is a low adhesiveness surface in the state where the dress-up panel 4 is detached. On the contrary, the front surface of the front cover 40 may have low adhesiveness. In this case, the dress-up panel 4 will consist of only the appearance member 4a.

As shown in FIG. 4A and FIG. 4B, the dress-up panel 4 can be detached when a user hangs a finger (or a claw) on a concave part 40ac provided in sections of the front cover 40 and frame member 30b that face the notch section 30c in the front side of the digital camera 1. Since the concave part 40ac is provided not at the side of the release button 6 but the side of the attachment part 30, a user is able to detach the dress-up panel 4 easily by putting a finger into the opening 30a, hanging the fingertip on the concave part 40ac, and raising the projecting part 4d of the dress-up panel 4 by the finger.

Further characteristic features of the digital camera 1 will be described hereinafter. The front cover 40 and rear cover 50 are made from elastomer material like rubber and cover the housing (not shown). That is, except the external apparent members, such as the image pickup lens 2, the digital camera 1 is covered by the elastomer components that function as a shock absorber. Accordingly, even when a user drops the digital camera 1 erroneously, damage to the image sensor and electronic parts in the housing can be reduced because impact on the housing can be softened. Moreover, since the elastomer components are used as exterior, the elasticity and high grip performance of the elastomer components effectively reduce prospect of unintentional slipping and dropping from a hand even when a user holds the digital camera 1 by the single hand.

Next, a second embodiment will be described. The position at which the notch section 30c is provided in the attachment part 30 is not limited to the position that faces the image pickup lens 2 as described in the first embodiment. In the second embodiment, a configuration in which the position of the notch section is changed will be described. It should be noted that the same reference numerals are applied to components identical to the components of the digital camera 1 concerning the first embodiment and duplicated descriptions are omitted in the following description.

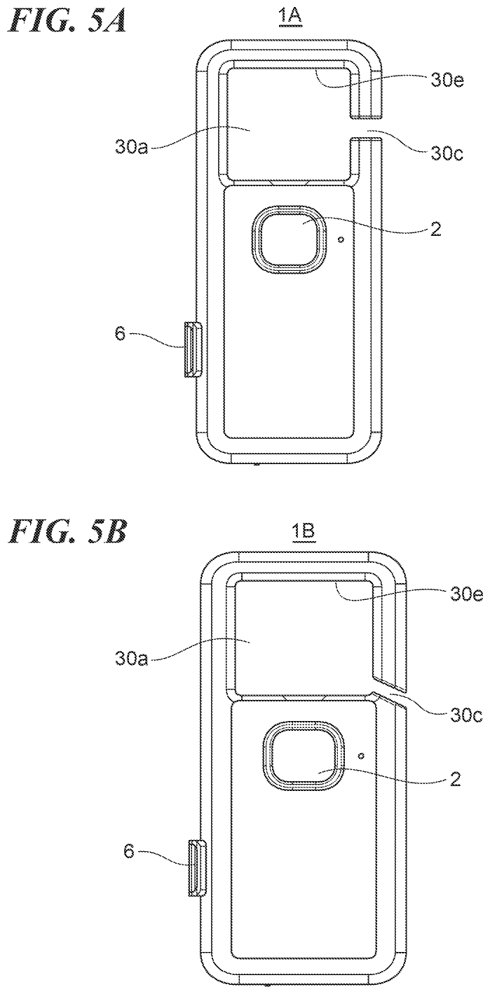

FIG. 5A is a front view schematically showing a configuration of a digital camera 1A of a first example concerning the second embodiment. The digital camera 1A has a notch section 30c that is formed by cutting out the attachment part 30 at a section that intersects perpendicularly with the mounted-member contact surface 30e in a direction that is approximately identical to the operation direction of the release button 6. In this way, since the notch section 30c is arranged at the position different from the mounted-member contact surface 30e to which a mounted member (not shown) contacts to support the digital camera 1A in a state where the attachment part 30 is attached to the mounted member, the mounted member hardly contacts the notch section 30c. Accordingly, even if a user hangs the digital camera 1A to a belt loop of trousers, a belt of a rucksack, or the like, the digital camera 1A does not depart easily (carelessly). Although the notch section 30c of the digital camera 1A is arranged on the surface of the front cover 40 different from the surface on which the release button 6 is arranged, the notch section 30c may be arranged on the same surface as the surface on which the release button 6 is arranged.

FIG. 5B is a front view schematically showing a configuration of a digital camera 1B of a second example concerning the second embodiment. The digital camera 1B has a notch section 30c that is formed by cutting out the attachment part 30 at the position near the standing wall that faces the mounted-member contact surface 30e so as to include a part of the section that faces the mounted-member contact surface 30e.

The notch section 30c of the digital camera 1B is also arranged at the position different from the mounted-member contact surface 30e to which a mounted member (not shown) contacts to support the digital camera 1B in a state where the attachment part 30 is attached to the mounted member. Accordingly, since the mounted member hardly contacts the notch section 30c when the digital camera 1 is hung to a mounted member, the attachment part 30 does not depart easily (carelessly) from the mounted member. Moreover, since the notch section 30c of the digital camera 1B is formed so as to incline by 90 degrees or smaller with respect to the long side of the digital camera 1B, the attachment part 30 is harder to drop out from the mounted member. In the meantime, when the user holds and pulls the digital camera 1 in a cutting direction of the notch section 30c, the user is able to detach the attachment part 30 of the digital camera 1 from the mounted member easily.

It should be noted that the outer portion of the notch section 30c, which contacts the mounted member when the digital camera 1 is attached to the mounted member, may be provided with a call-in shape like a C surface so as to achieve easier attachment. Furthermore, when only the forming portion of the notch section 30c is made from metal material, such as inelastic material (for example, aluminum die casting material that is obtained by casting (molding) aluminum alloy by a die casting method), attaching/detaching operability to a mounted member can be improved while securing the rigidity of the attachment part 30 and maintaining operability at the time of image pick-up.

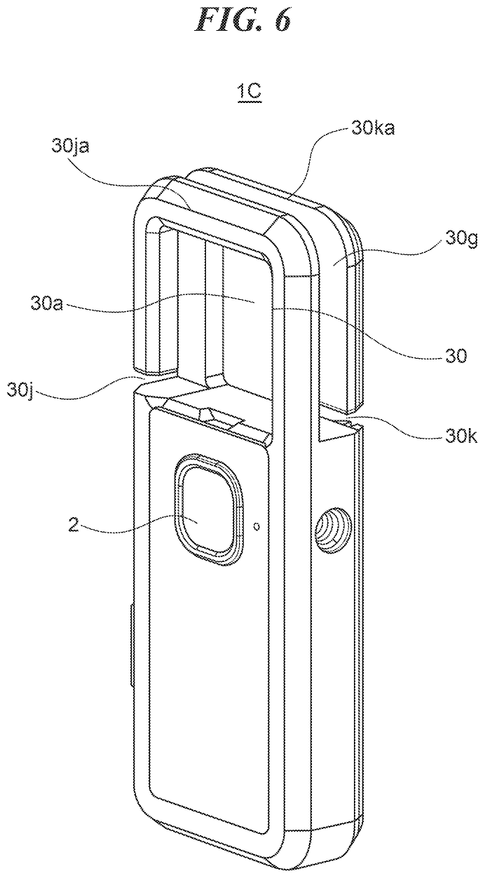

FIG. 6 is a front view schematically showing a configuration of a digital camera 1C of a third example concerning the second embodiment. The digital camera 1C is different from the above-mentioned digital cameras 1A and 1B at a point where the attachment part 30 is provided with two notch sections (a front notch section 30j and a rear notch section 30k). Hereinafter, this difference will be described mainly.

The attachment part 30 of the digital camera 1C has a front frame part (first frame part) 30ja at the side of the image pickup lens 2 and a rear frame part (second frame part) 30ka at the side of the rear grip part 8. A gap of a certain width is provided as an applied part 30g between the front frame part 30ja and rear frame part 30ka in the direction that intersects perpendicularly with the opening plane of the opening 30a. The applied part 30g is a space that allows passage of the mounted member (not shown) when a state where the mounted member is passing through the opening 30a of the attachment part 30 is achieved.

The front notch section 30j is provided in a part of the front frame part 30ja, and the rear notch section 30k is provided in a part of the rear frame part 30ka. The front notch section 30j and the rear notch section 30k are provided in mutually diagonal positions in the attachment part 30, and are provided in the positions that do not overlap when viewed in all of a width direction, a longitudinal direction, and a thickness direction of the digital camera 1C.

The front notch section 30j, rear notch section 30k, and applied part 30g are preferably designed so that the sizes thereof will be suitable for a width of a desired mounted member in order to achieve the state where the mounted member is passing through the opening 30a of the attachment part 30. After passing the mounted member through the applied part 30g, the mounted member can be attached to the opening 30a by rotating the digital camera 1C around an axis parallel to the longitudinal direction so that the mounted member will pass through the front notch section 30j and rear notch section 30k. Such a configuration enables the user to easily attach the digital camera 1 to the mounted member by a single hand and enables the camera to be hardly dropped.

In this way, the digital camera 1C achieves the configuration excellent in portability because the user is able to pass the mounted member through the opening 30a easily without enlarging the attachment part 30 and the digital camera 1C is hardly dropped when attaching to the mounted member. Moreover, since it is unnecessary to enlarge the opening 30a, the function as the finder frame that is used to determine a field angle at the time of image pick-up can be maintained.

Next, a third embodiment will be described. In the first and second embodiments mentioned above, the attachment part 30 is configured to be immovable (not to have a movable part) by forming the attachment part 30 integrally with the front cover 40 and rear cover 50. Against this, in the third and fourth embodiments, a digital camera of which an attachment part is configured by providing a frame part that can partially or entirely slide against a camera body will be described.

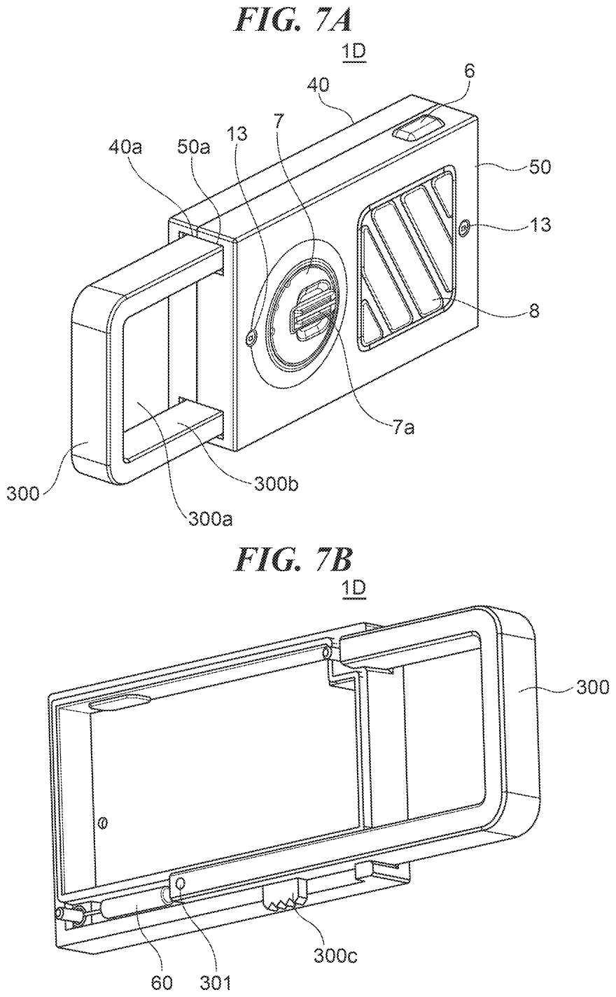

FIG. 7A is an external perspective view showing a digital camera I D of a first example of the third embodiment viewed from the rear side. FIG. 7B is a perspective view showing main components relevant to an operation of an attachment part 300 of the digital camera 1D. It should be noted that FIG. 7A and FIG. 7B show a state where the attachment part 300 is in a first position mentioned later. Moreover, the same reference numerals are applied to components of the digital camera 1D identical to the components of the digital camera 1 concerning the first embodiment and duplicated descriptions are omitted in the following description.

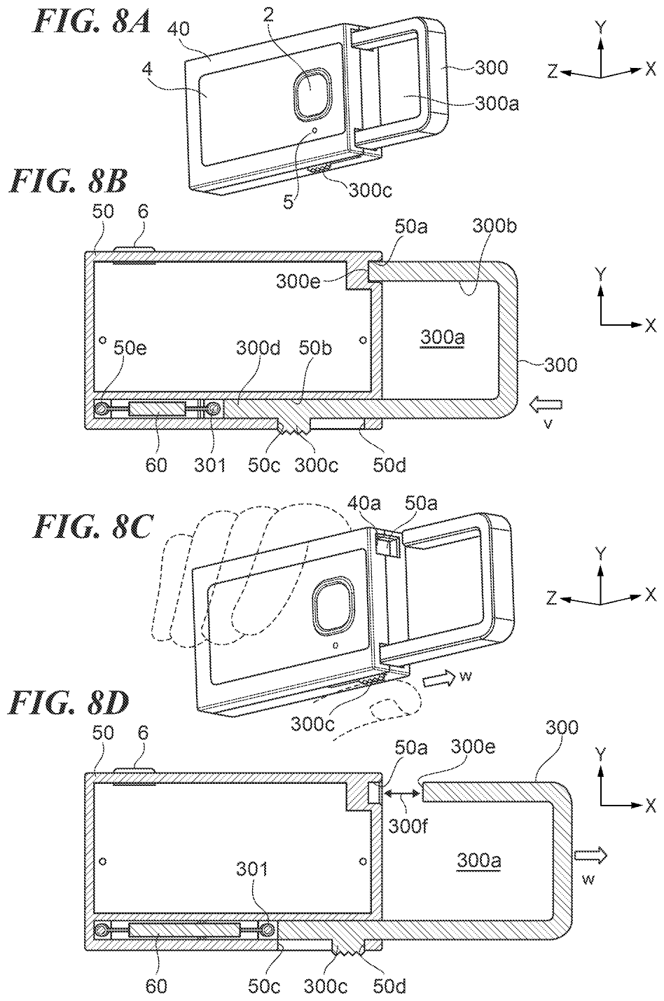

FIG. 8A is an external perspective view showing the digital camera 1D in the state where the attachment part 300 is in the first position viewed from the front side. As shown in FIG. 8A, a longitudinal direction of the digital camera 1D is defined as an X-direction, a width direction is defined as a Y-direction, and a thickness direction is defined as a Z-direction. FIG. 8B is an XY sectional view corresponding to the state of FIG. 8A. FIG. 8C is an external perspective view showing the digital camera 1D in a state where the attachment part 300 is in a second position viewed from the front side. FIG. 8D is an XY sectional view corresponding to the state of FIG. 8C.

The attachment part 300 is approximately formed in a J-shape, forms an opening 300a together with the camera body, and is made from rigid material like glass-fiber reinforced resin, for example. An inner circumferential surface 300b of the attachment part 300 and the camera body (the side surfaces of the front cover 40 and rear cover 50) form the rectangular opening 300a.

One end of a tension spring 60, which is an elastic member, engages with a projection 50e of the rear cover 50 and the other end engages with a shaft 302 of the attachment part 300. The tension spring 60 energizes the attachment part 300 in a direction of an arrow B shown in FIG. 8B so as to pull it into the camera body. In the meantime, an operation knob 300c for performing an opening motion with a finger is provided in the attachment part 300.

When the attachment part 300 is in the first position, the operation knob 300c is held in a state contacting an opening edge 50c of the rear cover 50 by energization force of the tension spring 60 as shown in FIG. 8B. Moreover, when the attachment part 300 is in the first position, a front end 300e of the attachment part 300 is buried into a concave portion 40a of the front cover 40 and a concave portion 50a of the rear cover 50, which forms an engagement part. When the attachment part 300 is in the first position, the opening 300a closes.

As with the opening 30a of the first and second embodiments, the opening 300a has a rectangular shape (including a rectangle of which corners are rounded) in order to check verticality and horizontality of composition easily when a user checks an object through the opening 300a as a finder frame.

As shown in FIG. 8C and FIG. 8D, when the user pushes the operation knob 300c with a finger in a direction of an arrow W that is an inverse direction of the direction of the arrow V, the operation knob 300c slides until contacting an opening edge 50d of the rear cover 50. In this way, the state where the operation knob 300c contacts the opening edge 50d is the state where the attachment part 300 is in the second position. When the attachment part 300 slides in the direction of the arrow W, an extending part 300d of the attachment part 300 moves along the groove 50b provided in the rear cover 50. Then, a gap 300f that communicates with the opening 300a is generated between the front end 300e of the attachment part 300 and the outer peripheries of the front cover 40 and rear cover 50.

The gap 300f that is generated in this way plays the same role as the notch section 30c formed in the attachment part 30 of the digital camera 1 concerning the first embodiment. That is, the user is able to hang the digital camera 1D to a mounted member (not shown), such as a string member or a belt, by inserting the mounted member into the opening 300a through the gap 300f that is generated when the attachment part 300 is in the second position. And also, the user is able to detach the mounted member from the opening 300a by removing the mounted member through the gap 300f.

Since the gap 300f is not generated when the attachment part 300 is in the first position, the mounted member that is passing through the opening 300a does not detach from the opening 300a, and accordingly, the digital camera 1D does not slip down. Moreover, the attachment part 300 is always energized toward the camera body (the direction of the arrow V shown in FIG. 8B) of the digital camera 1D by the tension spring 60. Accordingly, when the user stops the operation that slides the operation knob 300c in the direction of the arrow W shown in FIG. 8C and lifts a finger (hand) from the operation knob 300c, the attachment part 300 automatically returns to the first position by the energization force of the tension spring 60. In this way, the attachment part 300 can be easily attached to the mounted member and can be detached.

Moreover, when the attachment part 300 is in the first position, one front end 300e of the attachment part 300 is fit into the concave portions 40a and 50a and is held, and the extending part 300d engages with the groove portion 50b. Accordingly, even if external force acts on the attachment part 300 in a direction (the width direction of the digital camera 1D) that is approximately orthogonal to the direction of the arrow V in the state where the attachment part 300 is in the first position, the attachment part 300 hardly deforms.

Furthermore, as shown in FIG. 8C, when the attachment part 300 of the digital camera 1D is moved to the second position, an operation finger of the user does not come around the generated gap 300f. Accordingly, the excellent operativity can be obtained because the operation finger that moves the attachment part 300 to the second position and the finger after the movement do not disturb the attaching/detaching operation of the digital camera 1D to the mounted member.

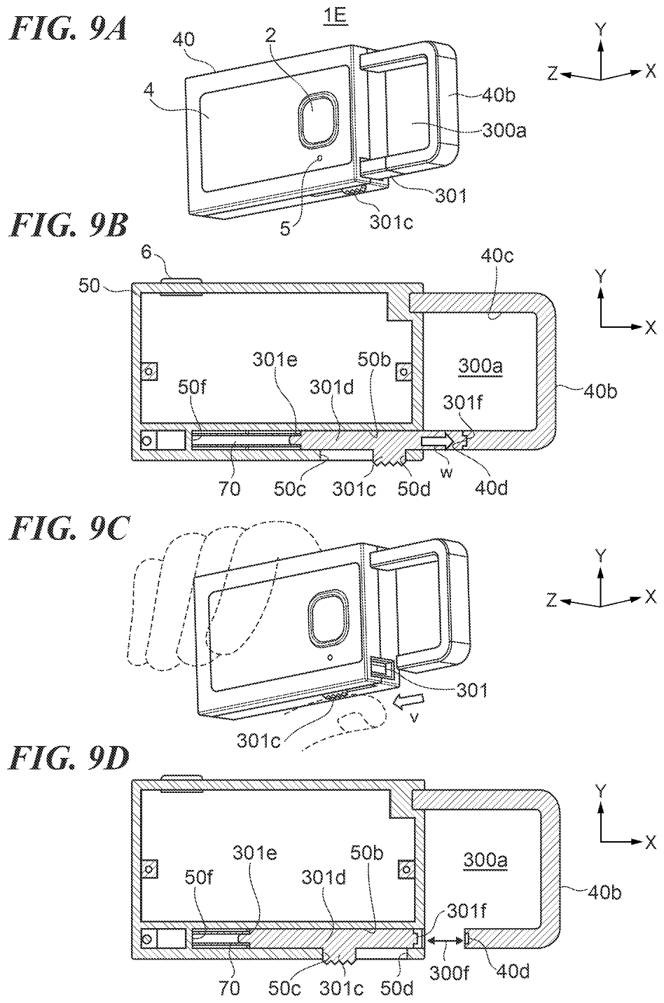

FIG. 9A is an external perspective view showing a digital camera 1E of a second example of the third embodiment viewed from the front side and shows a state where an attachment part 300 is in a first position. FIG. 9B is an XY sectional view corresponding to the state of FIG. 9A. FIG. 9C is an external perspective view showing the digital camera 1E in a state where the attachment part 300 is in a second position viewed from the front side. FIG. 9D is an XY sectional view corresponding to the state of FIG. 9C.

The digital camera 1D of the first example is constituted so that the attachment part 300 is slidable as a whole. In the meantime, the attachment part 300 of the digital camera 1E of the second example consists of a stationary member 40b and a movable member 301 that is slidable. Hereinafter, this difference will be described mainly. Moreover, the same reference numerals are applied to components of the digital camera 1E identical to the components of the digital camera 1D and duplicated descriptions are omitted in the following description.

A rectangular opening 300a is formed by the movable member 301, the stationary member 40b, and a camera body. As with the opening 30a of the digital camera 1 concerning the first embodiment, the opening 300a has a rectangular shape (including a rectangle of which corners are rounded) in order to check verticality and horizontality of composition easily when a user checks an object through the opening 300a as a finder frame.

The movable member 301 has an I-shape and is made from rigid material like glass-fiber reinforced resin. An extending part 301d of the movable member 301 is held so as to be slidable in a direction of an arrow W and its contour (surface) fits into a groove 50b provided in a rear cover 50. The stationary member 40b is integrally formed with a front cover 40 and is a rigid body that is immovable with respect to the camera body.

One end of a compression spring 70, which is an elastic member arranged at the camera body, contacts a supporting surface 50f of the rear cover 50 and the other end contacts an end 301e of the movable member 301. The compression spring 70 is energizing the movable member 301 in the direction of the arrow W. An operation knob 301c for performing an opening motion of the movable member 301 with a finger is provided in the attachment part 300. The operation knob 301c is held in a state where the operation knob 301c contacts an opening edge 50d of the rear cover 50 by the energization force of the compression spring 70. An edge projection 301f of the movable member 301 is buried in an edge concave portion 40d of the stationary member 40b so that an engagement part will be formed. This is the state where the movable member 301 is in the first position.

As shown in FIG. 9C, when a user pulls the operation knob 301c in a direction of an arrow V with a finger, the extending part 301d of the movable member 301 slides along the groove 50b of the rear cover 50 and the operation knob 301c will move to a position where the operation knob 301c contacts the opening edge 50c of the rear cover 50. This is the state where the movable member 301 is in a second position.

When the movable member 301 moves to the second position, a gap 300f is generated between the side surfaces of the front cover 40 and rear cover 50 and the edge concave portion 40d of the stationary member 40b. The gap 300f generated in this way plays the same role of the gap 300f described about the digital camera 1D concerning the third embodiment. That is, the user is able to hang the digital camera 1D to a mounted member (not shown), such as a string member or a belt, by inserting the mounted member into the opening 300a through the gap 300f that is generated when the movable member 301 is in the second position. And also, the user is able to detach the mounted member from the opening 300a by removing the mounted member through the gap 300f.

Since the gap 300f is not generated in the state where the movable member 301 is in the first position, the mounted member that is passing through the opening 300a does not slip down from the gap 300f. Moreover, since the movable member 301 is always energized in the direction of the arrow W by the compression spring 70, when the user stops the operation that slides the operation knob 300c in the direction of the arrow V and lifts a finger from the operation knob 300c, the movable member 301 automatically returns to the first position by the energization force of the compression spring 70. In this way, the attachment part 300 can be easily attached to the mounted member and can be detached.

Moreover, when the movable member 301 is in the first position, the edge projection 301f of the movable member 301 is held in the state engaging with the edge concave portion 40d of the stationary member 40b, and the extending part 301d engages with the groove portion 50b. Accordingly, even if external force acts on the attachment part 300 in a direction that is approximately orthogonal to the direction of the arrow W in the state where the movable member 301 is in the first position, the movable member 301 hardly deforms.

Furthermore, as shown in FIG. 9C, when the movable member 301 of the digital camera 1E is moved to the second position, an operation finger of the user does not come around the gap 300f. Accordingly, the excellent operativity can be obtained because the operation finger that moves the movable member 301 to the second position and the finger after the movement do not disturb the attaching/detaching operation of the digital camera 1E to the mounted member.

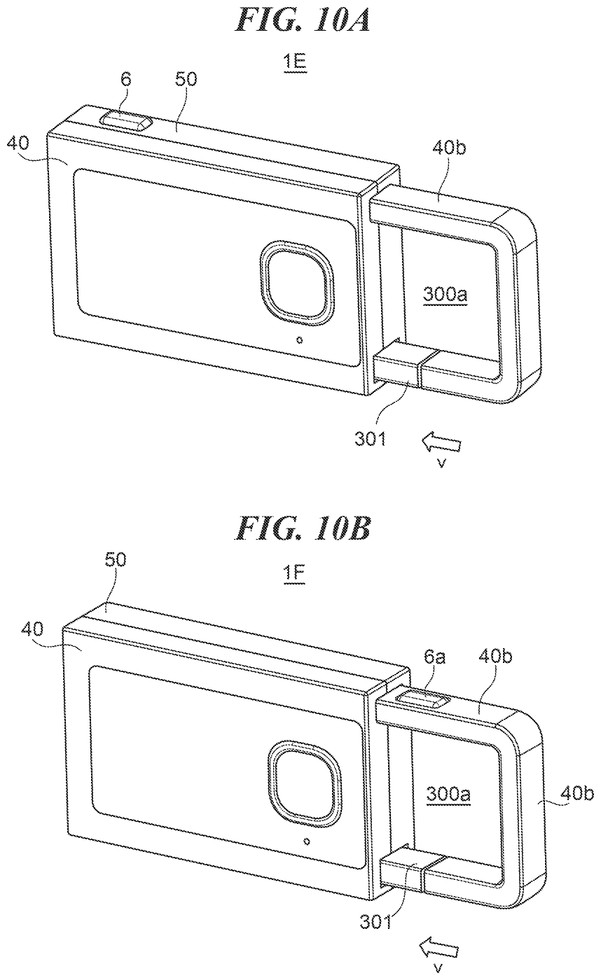

FIG. 10A is an external perspective view showing the digital camera 1E. In the digital camera 1E, a release button 6 is arranged on an upper surface of the rear cover 50 at a position away from the stationary member 40b and movable member 301. Moreover, since the pushing direction of the release button 6 intersects perpendicularly with the slide direction (the direction of the arrow V) of the movable member 301, the movable member 301 does not move in the direction toward the second position (the direction of the arrow V) erroneously at a time of a release operation. Accordingly, even if a user performs the release operation in the state where the mounted member (not shown) is inserted in the opening 300a, slipping-down of the mounted member from the opening 300a is prevented because the movable member 301 does not move and the gap 300f is not generated.

FIG. 10B is an external perspective view of a digital camera 1F that is a modified example of the digital camera 1E. In the digital camera 1F, a release button 6 is provided in an upper surface of a stationary member 40b that is integrally formed with a front cover 40. Since a movable member 301 and a configuration that slidably holds the movable member 301 with the front cover 40 and rear cover 50 are identical to that of the digital camera 1E, their descriptions are omitted.

In the digital camera 1F, the release button 6 is provided at a position near the movable member 301. Moreover, since the pushing direction of the release button 6 intersects perpendicularly with the slide direction (the direction of the arrow V) of the movable member 301, the movable member 301 does not move in the direction toward the second position (the direction of the arrow V) erroneously at a time of a release operation.

Moreover, even if a user holds the digital camera 1F by grasping the stationary member 40b or the movable member 301 from outside in a direction that is approximately orthogonal to the arrow V, the movable member 301 does not slide carelessly because it is not a rotary member like a carabiner. Since the rectangular shape of the opening 300a is maintained even if grip of the stationary member 40b or the movable member 301 is grasped by a user, the function of a finder frame is not lowered.

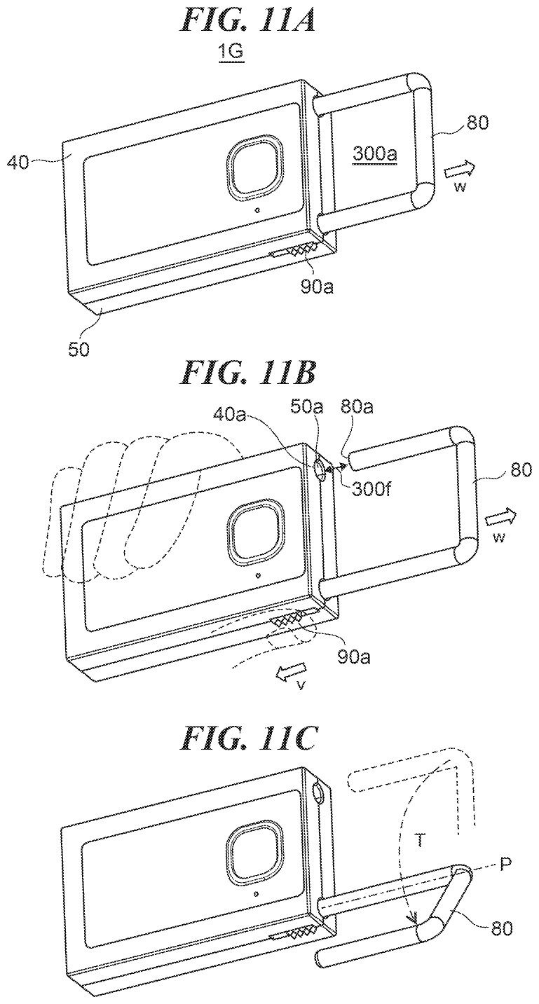

Next, a fourth embodiment will be described. FIG. 11A is an external perspective view showing a digital camera 1G concerning the fourth embodiment in a state where an attachment part 80 of the digital camera 1G is in a first position. FIG. 11B is a view describing a slide operation of the attachment part 80 of the digital camera 1G in a state where the attachment part 80 is in a second position. FIG. 11C is a view describing a rotary action of the attachment part 80 in a state where the attachment part 80 is in a third position.

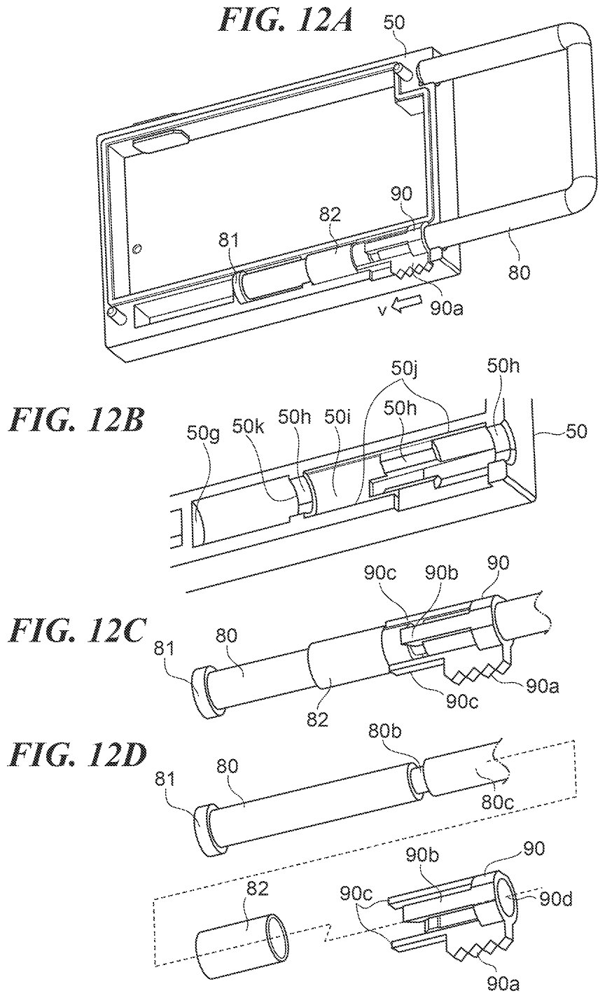

The digital camera 1D of the first example of the third embodiment is configured so that the attachment part 300 is slidable as a whole. Against this, the attachment part 80 of the digital camera 1G concerning the fourth embodiment is slidable and rotatable as a whole and is latched to a camera body with a latching member 90 (see FIG. 12A) in a state where an opening 300a is formed. Hereinafter, the configuration and operation of the attachment part 80 that are different from the digital camera 1D will be described.

The attachment part 80 is formed in a J-shape (see FIG. 12A) and is made from rigid material like metal. When being in the first position shown in FIG. 11A, the attachment part 80 is latched by the latching member 90, and the attachment part 80, a front cover 40, and a rear cover 50 form the rectangular opening 300a. Since the attachment part 80 is latched by the latching member 90 in the first position, the attachment part 80 does not slide even if a user tries to hold and pull the attachment part 80 in a direction of an arrow W shown in FIG. 11A.

As shown in FIG. 11B, when the user moves an operation knob 90a of the latching member 90 in a direction of an arrow V with a finger, the latch of the latching member 90 to the attachment part 80 is released. When the latch to the attachment part 80 is released, the user can pull out the attachment part 80 by sliding it in the direction of the arrow W. In this way, the position where the attachment part 80 has been pulled out from the camera body to the limit is the second position of the attachment part 80.

When the attachment part 80 is in the first position, a front end 80a of the attachment part 80 is fit into a concave portion 40a of the front cover 40 and a concave portion 50a of the rear cover 50, which forms an engagement part. When the attachment part 80 moves to the second position, the front end 80a of the attachment part 80 departs from the concave portions 40a and 50a, and a gap 300f is generated between the front end 80a and the side surfaces of the front cover 40 and rear cover 50.

The attachment part 80 pulled out in the direction of the arrow W is rotatable in a direction of an arrow T around a rotation axis P as shown in FIG. 11C. The position where the attachment part 80 has been rotated by a predetermined angle (for example, 180 degrees) from the second position around the rotation axis P is the third position of the attachment part 80. The attachment part 80 may rotate in a direction opposite to the direction of the arrow T and the predetermined angle is not limited to 180 degrees. That is, the attachment part 80 is freely rotatable around the rotation axis P.

Next, a configuration that enables the attachment part 80 to be movable between the first position and the third position will be described. FIG. 12A is a perspective view showing main members relevant to holding and operation of the attachment part 80 viewed from the front. FIG. 12B is a perspective view showing a part (attached unit) of the rear cover 50 to which the attachment part 80 is attached viewed from the front. FIG. 12C is a perspective view showing the attached unit. FIG. 12D is an exploded perspective view showing the configuration of the attached unit.

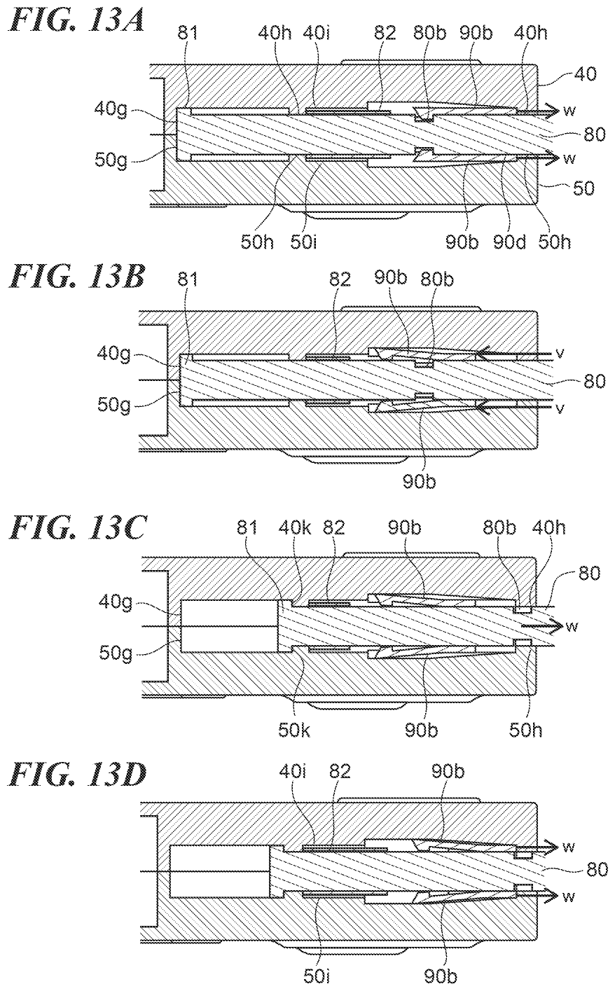

FIG. 13A is a sectional view showing a state where the attachment part 80 is latched by the latching member 90 at the first position. FIG. 13B is a sectional view showing a state where the attachment part 80 is in the first position and a release operation of the latching member 90 is performed. FIG. 13C is a sectional view showing a state where the release operation of the latching member 90 has been performed and the attachment part 80 has moved to the second position. FIG. 13D is a sectional view showing a state where the attachment part 80 is in the second position and the release operation of the latching member 90 is not performed.

As shown in FIG. 12A, the attachment part 80 is inserted into the latching member 90 and a compression spring 82 that is an elastic member. Moreover, a stopper 81 thicker than an outer diameter of the attachment part 80 is joined to the end of the attachment part 80. This prevents slipping-down of parts to which the attachment part 80 from the attachment part 80.

As shown in FIG. 12B, the rear cover 50 to which the attachment part 80 is attached has a supporting surface 50g that contacts the stopper 81 at a first position that is a pulling-in end of the attachment part 80 and a supporting surface 50k that contacts the stopper 81 at a second position that is a pulling-out end of the attachment part 80. Moreover, the rear cover 50 has a plurality of supporting surfaces 50h that support an outer periphery (peripheral surface) of the attachment part 80, a housing surface 50i that stores the compression spring 82, and a plurality of supporting surfaces 50j that hold elastic-member support parts 90c of the latching member 90 so as to be slidable in the direction of the arrow V.

As shown in FIG. 12C, the attachment part 80 is inserted (movably fit) into a fitting hole 90d of the latching member 90. And a plurality of latching parts 90b of the latching member 90 latch a groove 80b provided in the attachment part 80. As shown in FIG. 12D, each of the latching parts 90b of the latching member 90 is extended in cantilever form from a vicinity of the fitting hole 90d and is able to deform elastically in the radial direction of the attachment part 80 inserted between the latching parts 90b. One end of the compression spring 82 contacts end faces of elastic-member support parts 90c provided in the latching member 90. The latching member 90 has an operation knob 90a for releasing latch of the latching member 90 to the attachment part 80 from outside.

The front cover 40 is provided with supporting surfaces 40g, 40k, 40h, and 40j and a housing surface 40i that respectively have the same functions of the supporting surfaces 50g, 50k, 50h, and 50j and the housing surface 50i of the rear cover 50 so as to face mutually. It should be noted that the supporting surfaces 50h and the supporting surfaces 40h constitute a support mechanism that rotatably supports the attachment part (frame part) 80. As shown in FIG. 13A, one end of the compression spring 82 contacts the ends of the housing surfaces 40i and 50i, and the other end contacts the end surfaces of the elastic-member support parts 90c. Accordingly, the latching member 90 is energized in the direction of the arrow W by the compression spring 82 and moves to the position where the latching member 90 contacts the ends of the supporting surfaces 40h and 50h. Since the plurality of latching parts 90b latch the groove 80b, the user cannot slide the attachment part 80 in the direction of the arrow W. Since the stopper 81 that is integrally formed with the attachment part 80 contacts the supporting surfaces 40g and 50g, the attachment part 80 in the first position is held in a state closed to the front cover 40 and rear cover 50.

As shown in FIG. 13B, when the operation knob 90a is operated in the direction of the arrow V that is inverse to the energized direction by the compression spring 82, the elastic-member support parts 90c compress the compression spring 82 and the latching parts 90b overcome the groove 80b. Thereby, the latch to the groove 80b (the attachment part 80) by the latching parts 90b is released.

As shown in FIG. 13C, the user slides the attachment part 80 in the direction of the arrow W while compressing the compression spring 82 in the state where the latch to the groove 80b by the latching parts 90b is released until the stopper 81 contacts the supporting surfaces 40k and 50k. Thereby, the attachment part 80 moves to the second position that is separated from the front cover 40 and rear cover 50. Since the attachment part 80 is cylindrical, the section of the attachment part 80 supported by the supporting surfaces 40h and 50h is circular. Accordingly, the attachment part 80 is rotatable around the rotation axis P as long as the front end 80a of the attachment part 80 exits from the concave portions 40a and 50a as shown in FIG. 11B.

When the user lifts the finger from the operation knob 90a after the state of FIG. 13C is achieved, the compression spring 82 presses the elastic-member support parts 90c (see FIG. 12C) of the latching member 90 in the direction of the arrow W. Thereby, the latching member 90 is pushed until contacting the ends of the supporting surfaces 40h and 50h as shown in FIG. 13D. When the attachment part 80 is pushed in the direction of the arrow V until the stopper 81 contacts the supporting surfaces 40g and 50g from the state of FIG. 3D, the plurality of latching parts 90b of the latching member 90 fit into the groove 80b, and the attachment part 80 returns to the state of FIG. 13A again where the attachment part 80 is latched in the first position.

As mentioned above, when the attachment part 80 of the digital camera 1G has been moved to the second position, a finger that a user operates the digital camera 1G does not come around the gap 300f. Accordingly, a. finger that operates the attachment part 80 to move to the second position and a finger after the movement hardly disturb the attachment and detachment of the digital camera 1G to a mounted member, which facilitates the attachment and detachment.

Moreover, since the attachment part 80 of the digital camera 1G is rotatable around the rotation axis P, the gap 300f can be larger than the gaps of the above-mentioned digital camera 1E etc. Accordingly, a user is able to pass a mounted member with a large diameter or large width through the opening 300a and to hang and carry the digital camera 1G.

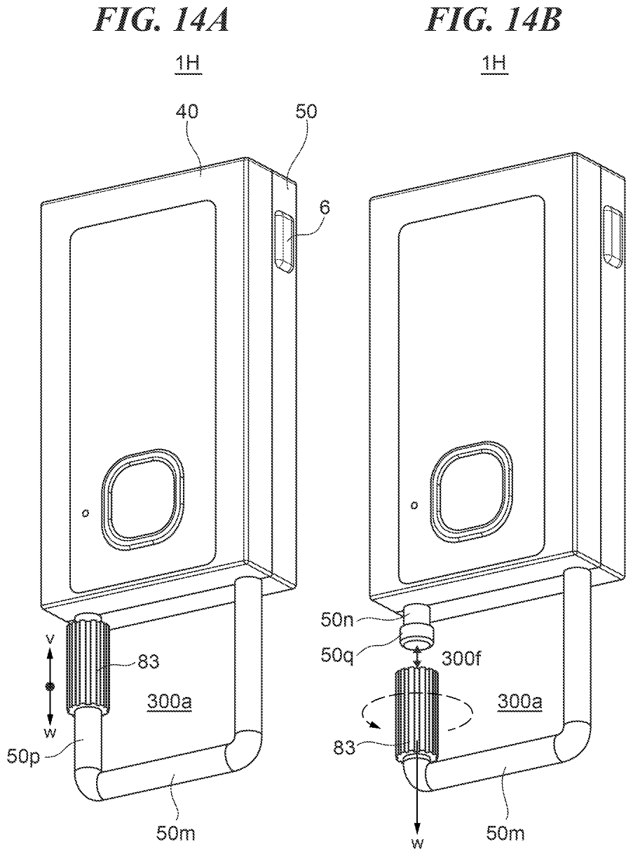

Next, a fifth embodiment will be described. FIG. 14A and FIG. 14B are external perspective views showing a digital camera concerning the fifth embodiment. The digital camera 1H has a movable member 83. FIG. 14A shows a state where the movable member 83 is in a first position. FIG. 14B shows a state where the movable member 83 is in a second position.

The digital camera 1H has two stationary members 50m and 50n that are fixed to a camera body. The movable member 83 is attached to the stationary member 50m. The movable member 83 and the stationary members 50m and 50n constitute an attachment part. The movable member 83 is movable between a first position and a second position. When being in the first position, the movable member 83 engages with the stationary member 50n so as to close an opening 300a. When being in the second position, the movable member 83 separates from the stationary member 50n and generates a gap 300f that communicates with the opening 300a.

In detail, the stationary members 50m and 50n are integrally formed with a rear cover 50 so as not to move, respectively. The gap 300f is given between the stationary members 50m and 50n. The movable member 83 is attached to a front end 50p of the stationary member 50m so as to be slidable in directions of arrows V and W. An internal screw part (not shown) is formed on an inner surface of the movable member 83. An external screw part 50q is formed at a front end of the stationary member 50n. Accordingly, when the movable member 83 is moved in the direction of the arrow V and is rotated so as to screw the internal screw part to the external screw part 50q, the gap 300f will close and the stationary members 50m and 50n will be connected by the movable member 83.

In this way, when the movable member 83 engages with the stationary member 50n and the gap 300f closes as shown in FIG. 14A, the movable member 83 is in the first position. When the gap 300f is closed, the rectangular opening 300a is formed in a closed state by a part of side surfaces of a front cover 40, a part of side surfaces of the rear cover 50, the movable member 83, and the stationary members 50m and 50n.

FIG. 14B shows the state where the gap 300f between the stationary member 50m (movable member 83) and the stationary member 50n has opened because the screwing between the movable member 83 and the stationary member 50n was released and the movable member 83 slid in the direction of the arrow W by self-weight. In this way, the position of the movable member 83 that generates the state where the gap 300f opened is the second position. As with each of the above-mentioned embodiments, a mounted member (not shown) can be inserted into the opening 300a or can be exited through the gap 300f.

When the movable member 83 of the digital camera 1H has been moved to the second position, a finger that a user operates the digital camera 1H does not come around the gap 300f. Accordingly, a finger that operates the movable member 83 to move to the second position and a finger after the movement hardly disturb the attachment and detachment of the digital camera 1H to a mounted member, which facilitates the attachment and detachment.

Although the digital camera 1H employs the configuration that the movable member 83 is screwed to the stationary member 50n, another configuration may be employed. That is, it is enough that the slidable movable member moves between the first position to be connected to the stationary member 50n (camera body) and the second position to be separated from the stationary member 5011 to generate the gap 300f. For example, the following configuration may be employed. The movable member 83 is attached to the front end 50p so as to be pushed to the stationary member 50n by an elastic member like a compression spring. When the movable member 83 is shifted to the stationary member 50n, the gap 300f closes. Then, when the movable member 83 is slid in the direction inverse to the pushed direction, the movable member 83 is separated from the stationary member 50n and the gap 300f is generated.

Since the digital camera concerning each of the third, fourth, and fifth embodiments mentioned above has the engagement part or the screwing part between the movable member and the camera body, the movable member does not move easily as long as the movable member is not operated. Accordingly, since the rectangular shape of the attachment part is maintained, the function of the attachment part as the finder frame does not lower and the digital camera does not slip down in the state where the mounted member is passing through the attachment part (opening 300a) because the gap 300f is not generated.

Moreover, the opening 300a of the digital camera of each of the third, fourth, and fifth embodiments is used as the same finder visual field frame as the opening 30a of the digital camera of each of the first and second embodiment. Accordingly, the shapes of the openings 30a and 300a should be usable as a finder frame and size and shape should be suitable to the field angle and cannot be determined freely. Moreover, the openings 30a and 300a are preferably arranged near the image pickup lens 2 so as to diminish parallax between the image pickup field and the field frame looked through the finder. Furthermore, the inner circumferential surface of the finder frame preferably inclines toward a position of an eye of an estimated user according to the position of the eye of the user in order to prevent the vignetting by the inner circumferential surface of the finder frame when the user looks into the finder frame (openings 30a and 300a). When these requests are taken into consideration, the shapes of the openings 30a and 300a are determined on the basis of the field angle of the image pickup lens 2, the relative position to the image pickup lens 2, and the approximate position of the eye to the digital camera when the user looks into the openings 30a and 300a as the finder frames.

In this case, if the attachment part is provided with a swing lever that can be swung inside of the opening 30a, it is necessary to enlarge the swing lever in order to facilitate an swing operation and not to disturb attachment and detachment of the mounted member by the swing lever or a finger during a swing operation. However, since the size of the opening 30a is restricted, the size of the swing lever may not be enlarged even though wanted. Moreover, when the swing lever becomes larger, it becomes more difficult to pass a strap etc. in the state where the swing lever is pushed in. Against this, since the movable members of the digital cameras concerning the third, fourth, and fifth embodiments are slidable, the configuration where the finger after the slide operation and the attachment part after the movement hardly disturb attachment and detachment of the mounted member is achievable irrespective of the size of the opening 300a.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-007681, filed Jan. 21, 2020, which is hereby incorporated by reference herein in its entirety.

What is claimed is:

1. An image pickup apparatus comprising:
a body part configured to have an image pickup lens; and
a frame part configured to have an opening,
wherein the frame part is provided with a notch section that is formed by cutting out a part of the frame part in a direction different from a natural falling direction of the image pickup apparatus.

2. The image pickup apparatus according to claim 1, wherein the frame part has a contact surface, and
wherein the notch section is formed by cutting out a part of the contact surface in a direction different from a direction that intersects perpendicularly with the contact surface.

3. The image pickup apparatus according to claim 1, wherein the frame part has a contact surface, and
wherein the notch section is formed in a part that intersects perpendicularly with the contact surface in the frame part.

4. The image pickup apparatus according to claim 1, wherein the frame part has a contact surface, and
wherein the notch section is formed so as to include a part that faces the contact surface.

5. The image pickup apparatus according to claim 2, wherein the contact surface contacts a mounted member in a case where the image pickup apparatus is hung to the mounted member that is passing through the opening.

6. The image pickup apparatus according to claim 3, wherein the contact surface contacts a mounted member in a case where the image pickup apparatus is hung to the mounted member that is passing through the opening.

7. The image pickup apparatus according to claim 4, wherein the contact surface contacts a mounted member in a case where the image pickup apparatus is hung to the mounted member that is passing through the opening.

8. The image pickup apparatus according to claim 1, wherein the frame part has a first frame part and a second frame part that are formed to have a predetermined gap in a direction that intersects perpendicularly with an opening plane of the opening, and
wherein a first notch section and a second notch section are respectively provided in the first frame part and the second frame part in positions that do not overlap in a case where the first notch section and the second notch section are viewed at least in the direction that intersects perpendicularly with the opening plane of the opening.

9. An image pickup apparatus comprising:
a body part configured to have an image pickup lens; and
a frame part configured to form an opening together with the body part,
wherein at least a part of the frame part is slidable between a first position in which the opening closes and a second position in which a gap that communicates with the opening is generated.

10. The image pickup apparatus according to claim 9, further comprising an elastic member configured to energize the frame part as a whole to slide in the direction to the first position from the second position.

11. The image pickup apparatus according to claim 9, wherein the frame part comprises:
a stationary member configured to be fixed to the body part, a movable member configured to be slidable between the first position and the second position to the body part, and
an elastic member configured to energize the movable member to slide in the direction to the first position from the second position, and
wherein the gap is generated between the movable member and the stationary member in a case where the movable member is in the second position.

12. The image pickup apparatus according to claim 11, wherein a release button of which an operation direction intersects perpendicularly with a slide direction of the movable member.

13. The image pickup apparatus according to claim 9, further comprising a latching member configured to latches the frame part as a whole in the first position, and
wherein the frame part becomes slidable from the first position to the second position in a case where latch by the latching member is released.

14. The image pickup apparatus according to claim 13, wherein the body part is further provided with a support mechanism that rotatably supports the frame part in a case where the frame part is in the second position.

15. The image pickup apparatus of claim 9, wherein the frame part comprises:
two stationary members configured to be fixed to the body part so that a gap is generated therebetween, and
a movable member configured to be attached to one of the two stationary members movably,
wherein the movable member connects the two stationary members so as to close the gap in a case where the movable member is in the first position, and
wherein the gap is generated in a case where the movable member is in the second position.

16. The image pickup apparatus according to claim 1, wherein the body part and the frame part have a shape of a rectangular parallelepiped plate, and
wherein the frame part is provided in one end of the image pickup apparatus in a longitudinal direction so that an opening plane of the opening will become parallel to the longitudinal direction and a width direction of the image pickup apparatus.

17. The image pickup apparatus according to claim 16, wherein the image pickup lens is provided in a surface of the body part that is parallel to the opening plane of the opening and is provided near the opening.
